(19) United States
(12) Patent Application Publication
(10) Pub. No.: US 2011/0128272 A1
(43) Pub. Date: Jun. 2, 2011

(54) LIQUID CRYSTAL DISPLAY ACCEPTING ALTERNATING COMMON VOLTAGE

(75) Inventors: YU-SHENG CHEN, Miao-Li County (TW); YU-CHENG LIN, Miao-Li County (TW); WEN-MING HUNG, Miao-Li County (TW); YING-TSUNG LIN, Miao-Li County (TW); CHUEH-JU CHEN, Miao-Li County (TW)

(73) Assignee: CHIMEI INNOLUX CORPORATION, Miao-Li County (TW)

(21) Appl. No.: 12/948,773

(22) Filed: Nov. 18, 2010

(30) Foreign Application Priority Data
Nov. 30, 2009 (CN) 200910310672.1

(51) Int. Cl. G09G 5/00; G09G 3/36

(52) U.S. Cl. 345/211; 345/87

(57) ABSTRACT

A liquid crystal display includes a pixel matrix having a plurality of pixels and a common voltage driver. Each pixel includes a TFT, a pixel electrode, and a common electrode. The pixels are defined as a first pixel group and a second pixel group. The pixels in the first pixel group all have a first polarity in each frame period, the pixels in the second pixel group all have a second polarity in each frame period, and the first polarity and the second polarity are different. The common voltage driver is configured for providing a first common voltage to the common electrodes of the pixels in the first pixel group and providing a second common voltage to the common electrodes of the pixels in the second pixel group. The first common voltage and the second common voltage are alternating voltages, and have inverse phases.

### BACKGROUND

1. Technical Field

The present disclosure relates to liquid crystal display (LCD) technology, and more particularly, to an LCD accepting alternating common voltages.

2. Description of Related Art

LCDs have the advantages of portability, low power consumption, and low wradiation, and thus are widely used in various portable information products, such as notebooks, personal digital assistants, video cameras, and the like.

A commonly used LCD includes a plurality of pixel electrodes each configured to provide a pixel voltage, a common electrode configured to provide a common voltage, and a plurality of liquid crystal molecules driven by the pixel voltages and the common voltage. In order to protect the liquid crystal molecules from decay or damage, polarity inversion driving is used in the LCD. According to one polarity inversion driving method, in an Nth frame, a direct current (DC) common voltage is applied to the common electrode, and a first pixel voltage exceeding the common voltage is applied to a pixel electrode of an pixel unit; in an (N+1)th frame, and a second pixel voltage less than the common voltage is applied to the pixel electrode. As such, a polarity of the pixel unit is alternately changed during two consecutive frames, whereby the liquid crystal molecules are protected from decay.

However, in the described driving method, a voltage variation of the pixel electrode may be unduly great during two consecutive frames. In order to provide such pixel voltages, a data driving circuit for driving the pixel electrode needs be complicated, increasing cost of the LCD.

What is needed is an LCD that can overcome the described limitations.

### SUMMARY

An aspect of the disclosure relates to a liquid crystal display including a liquid crystal panel and a common voltage driver. The liquid crystal panel includes a plurality of parallel scanning lines, a plurality of parallel data lines perpendicular to the scanning lines, and a pixel matrix defined by the scanning lines and the data lines. The pixel matrix includes a plurality of pixels each having a thin film transistor, a pixel electrode connected to a drain of the thin film transistor, and a common electrode opposite to the pixel electrode, and the pixels are defined as a first pixel group and a second pixel group. The pixels in the first pixel group all have a first polarity and the pixels in the second pixel group all have a second polarity in each frame period. The common voltage driver is configured for providing a first common voltage to the common electrodes of the pixels in the first pixel group and providing a second common voltage to the common electrodes of the pixels in the second pixel group. The first common voltage and the second common voltage constitute an alternating voltage having inverse phases.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is a circuit diagram of an LCD according to a first embodiment of the present disclosure.

FIG. 2 illustrates polarities of pixels of LCD of FIG. 1 in a frame period.

FIG. 3 illustrates a timing chart for the LCD of FIG. 1.

FIG. 4 is a circuit diagram of an LCD according to a second embodiment of the present disclosure.

### DETAILED DESCRIPTION

Reference will now be made to the drawings to describe certain exemplary embodiments of the present disclosure in detail.

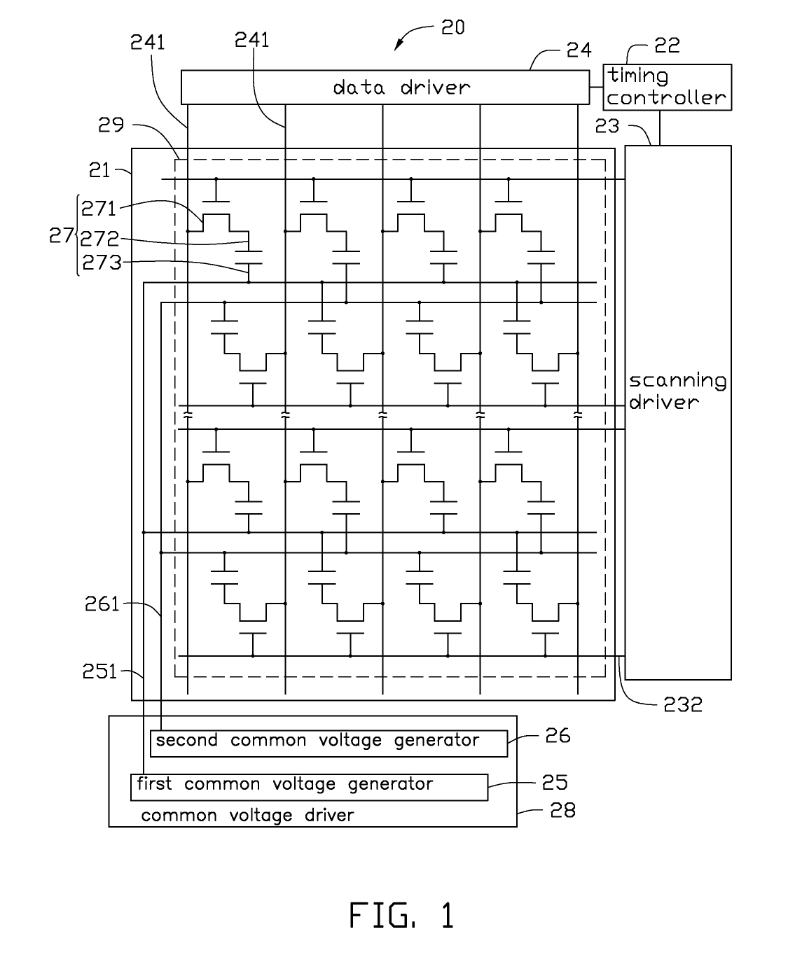

Referring to FIG. 1, a circuit diagram of an LCD 20 according to a first embodiment of the present disclosure is shown. The LCD 20 includes a timing controller 22, a scanning driver 23, a data driver 24, a common voltage driver 28, and a liquid crystal panel 21. The timing controller 22 is configured to provide a timing signal to the scanning driver 23 and the data driver 24, so as to control timings of the scanning driver 23 and the data driver 24, and additionally, the timing controller 22 may also be configured to provide RGB data signals to the data driver 24. The scanning driver 23 is configured to provide a plurality of scanning signals to the liquid crystal panel 21 according to the timing signal. The data driver 24 is configured to provide a plurality of data voltages to the liquid crystal panel 21 according to the timing signal and the RGB data signals. The common voltage driver 28 is configured to provide common voltages to the liquid crystal panel 21.

The liquid crystal panel 21 includes M rows of parallel scanning lines 232, N columns of parallel data lines 241 perpendicular to the scanning lines 232, and a plurality of pixels 27 cooperatively defined by the crossing scanning lines 232 and data lines 241. The pixels 27 cooperatively form a pixel matrix 29 having M rows and N columns. Each pixel 27 includes a thin film transistor (TFT) 271, a pixel electrode 272, and a common electrode 273. A gate electrode of the TFT 271 is electrically coupled to a corresponding scanning line 232, and a source electrode of the TFT 271 is electrically coupled to a corresponding data line 241. Further, a drain electrode of the TFT 271 is electrically coupled to the pixel electrode 272. The common electrode 273 generally opposite to the pixel electrode 272, and a plurality of liquid crystal molecules (not shown) are sandwiched between the pixel electrode 272 and the common electrode 273, and with this configuration, a liquid crystal capacitor (not labeled) is formed in each pixel 27.

In the LCD 20, the scanning lines 232 are electrically coupled to the scanning driver 23 for receiving the scanning signals, and the data lines 241 are electrically coupled to the data driver 24 for receiving the data voltages. Moreover, in one embodiment, the liquid crystal panel 21 may also include a first common providing line 251 for transmitting a first common voltage Vcom1, and a second common providing line 261 for transmitting a second common voltage Vcom2. For example, the first common providing line 251 and the second common providing line 261 may be parallel to the data lines 241, and located at a same side of a periphery of the pixel matrix 29, or respectively located at opposite sides of the periphery of the pixel matrix 29. The first common providing line 251 and the second common providing line 261 are electrically coupled to the common voltage driver 28 for receiving the first common voltage Vcom1 and the second common voltage Vcom2, respectively.

In one embodiment, the common voltage driver 28 may include a first common voltage generator 25 and a second common voltage generator 26. The first common voltage generator 25 is electrically coupled to the first common providing line 251, and configured to generate the first common voltage Vcom1 and provide the first common voltage Vcom1 to the first common providing line 251. The second common voltage generator 26 is electrically coupled to the second common providing line 261, and configured to generate the second common voltage Vcom2 and provide the second common voltage Vcom2 to the second common providing line 261.

To simplify the description, some definitions are provided herein, and the following disclosure is described based on these definitions. The pixel 27 is defined as the pixel having a positive polarity when a data voltage received by the pixel electrode 272 of the pixel 27 exceeds a common voltage received by the common electrode. Conversely, the pixel 27 is defined as the pixel having a negative polarity when the data voltage is lower than the common voltage. Accordingly, all the pixels 27 in the pixel matrix 29 can be divided into a first pixel group (not labeled) having positive polarity, and a second pixel group (not labeled) having the negative polarity, in a frame period.

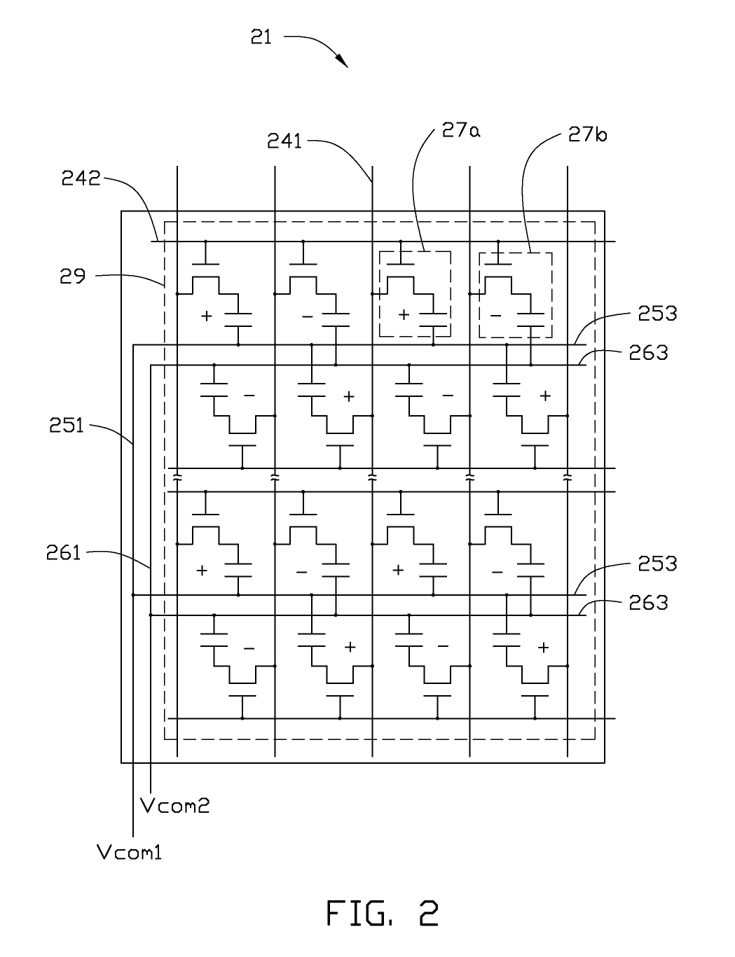

Referring to FIG. 2, a polarity inversion driving method referred to as one line dot inversion method may be applied to the LCD 20. In the illustrated embodiment, the pixels 27a located not only in odd rows but also in odd columns and the pixels 27a located not only in even rows but also in even columns are defined as belonging to the first pixel group, and thus these pixels 27a all have positive polarities. The pixels 27b located not only in odd rows but also in even columns and the pixels 27b located not only in even rows but also in odd columns are defined as belonging to the second pixel group, and thus these pixels 27b all have negative polarities. Moreover, the common electrodes 273 of the pixels 27a belonging to the first pixel group are electrically connected to the first common providing line 251, and the common electrodes 273 of the pixels 27b belonging to the second pixel group are electrically connected to the second common providing line 261. Thus, the first common voltage Vcom1 is applied to the pixels 27a belonging to the first pixel group, and the second common voltage Vcom2 is applied to the pixels 27a belonging to the second pixel group. Furthermore, the liquid crystal panel 21 may also include a plurality of first common lines 253 configured to electrically connect the common electrodes 273 of the pixels 27a to the first common providing line 251, and a plurality of second common lines 263 configured to electrically connect the common electrodes 273 of the pixels 27b to the second common providing line 261. The positions of the thin film transistors of any two adjacent pixels 27a, 27b in each row are the same.

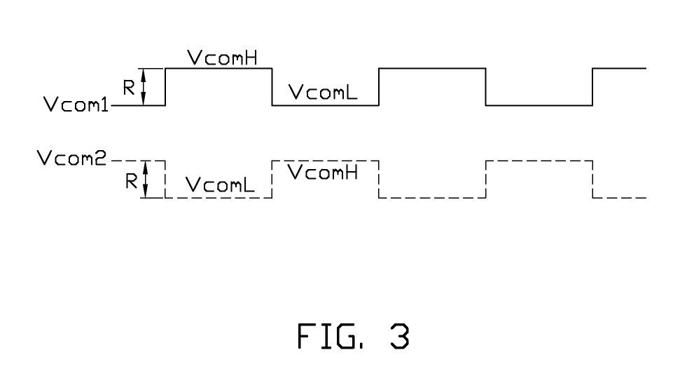

Referring to FIG. 3, a timing chart of the first common voltage Vcom1 and the second common voltage Vcom2 is shown. The first common voltage Vcom1 and the second common voltage Vcom2 are both alternating voltage signals, and additionally, the first common voltage Vcom1 and the second common voltage Vcom2 have same amplitude and same frequency, but have inverse phases at any time.

In detail, each of the first common voltage Vcom1 and the second common voltage Vcom2 is a continuous alternating square signal, which includes a maximum amplitude value VCOMH and a minimum amplitude value VCOML. In one embodiment, the maximum amplitude value VCOMH of the first common voltage Vcom1 and the second common voltage Vcom2 can be about 10V, and the minimum amplitude value VCOML of the first common voltage Vcom1 and the second common voltage Vcom2 can be about 5V. An amplitude R of the first and second common voltages may be defined as a difference between the maximum amplitude value VCOMH and the minimum amplitude value VCOML, and thus, the amplitude R of the first common voltage Vcom1 and the second common voltage Vcom2 can be about 5V.

Furthermore, a phase of the first common voltage Vcom1 is inverse compared to a phase of the second common voltage Vcom2. In particular, when the first common voltage Vcom1 is in the maximum amplitude value VCOMH, the second common voltage Vcom2 is in the minimum amplitude value VCOML. Conversely, when the first common voltage Vcom1 is in the minimum amplitude value VCOML, the second common voltage Vcom2 is in the maximum amplitude value VCOMH.

Data voltages provided by the data driver may have a maximum value, a minimum value, and a variation range defined by the maximum value and the minimum value. In one embodiment, the variation range of data voltages can exceed the amplitude R of the first common voltage Vcom1 and the second common voltage Vcom2, and this may improve stability of the first common voltage and the second common voltage. For example, the maximum value and the minimum value of data voltages can be preset as 15V and 0V respectively, such that the variation range of data voltages can be 15V.

Referring to FIGS. 2-3, in operation, assuming the pixels 27a in the first pixel group have positive polarities and the pixels 27b in the second pixel group have the negative polarities in an Nth frame, during the Nth frame, the scanning driver 23 provides a plurality of scanning signals to the scanning lines 232, thereby activating the pixels 27 row by row; the data driver 24 provides a plurality of data voltages to the data lines 241, and thereby the data voltages are provided to the pixel electrodes 272 of the activated pixels 27. Moreover, the common voltage driver 28 provides the first common voltage Vcom1 in the minimum amplitude value VCOML to the common electrodes 273 of the pixels 27a in the first pixel group via the first common providing line 251, and provides the second voltage Vcom2 in the maximum amplitude value VCOMH to the common electrodes 273 of the pixels 27b in the second pixel group via the second common providing line 261. Accordingly, the pixels 27a in the first pixel group have positive polarities, and the pixels 27b in the second pixel group have negative polarities, as shown in FIG. 2.

Further, during the (N+1)th frame, the polarity of each pixel is inversed to an opposite polarity, that is, the pixels 27a in the first pixel group have negative polarities, and the pixels 27b in the second pixel group have positive polarities. To perform such polarity reversion, in one embodiment, the first common voltage Vcom1, provided to the first pixel group via the first common providing line 251, may be switched from the minimum amplitude value VCOML to the maximum amplitude value VCOMH, and the second common voltage Vcom2, provided to the second pixel group via the second common providing line 261, may be switched from the maximum amplitude value VCOMH to the minimum amplitude value VCOML.

With the described configuration, while driven by an inversion method, the common voltage provided to the common electrode 273 of the pixel 27 can be switched between VCOML and the VCOMH, when the pixel 27 is switched from a positive polarity to a negative polarity, and vice versa. Therefore, the data voltages provided to the pixel electrodes 272 of the pixels 27 with positive polarities can be lowered, and the data voltages provided to the pixel electrodes of the pixels 27 with negative polarities can be heightened. As such, a variation range of each data voltage is reduced.

In summary, in the LCD 20 as disclosed, by use of the first common voltage Vcom1 and the second common voltage Vcom2, both of which are alternating voltages, the common voltage applied to each common electrode 272 can be changed according to the polarity switch of the corresponding pixel 27. Therefore, the variation range of each data voltage can be reduced. As such, a structure of the data driver 24 may be simplified, thereby minimizing cost of the LCD 20.

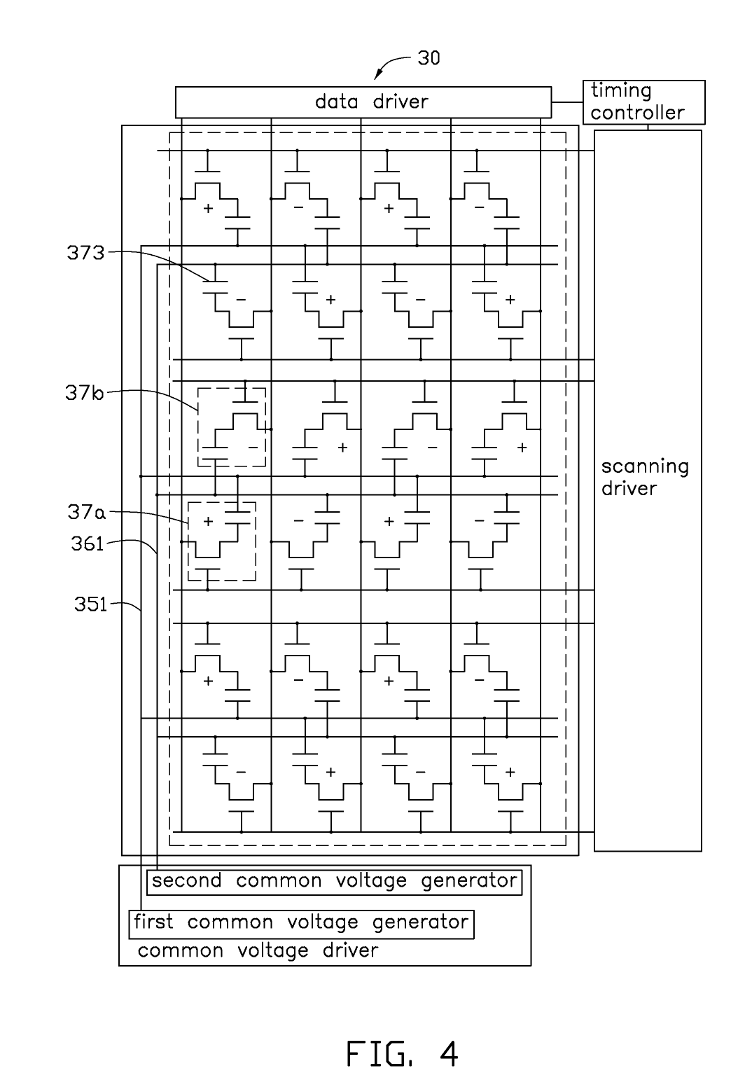

Referring to FIG. 4, a circuit diagram of an LCD 30 according to a second embodiment of the present disclosure is shown, differing from the previous embodiment in that a one and two (1+2) lines dot inversion polarity inversion driving method is used in the LCD 30, such that pixels 37a in odd columns of the first row, fourth row, fifth row, eighth row, ninth row and the pixels 37a in even columns of the second row, third row, sixth row, seven row belong to a first pixel group, and common electrodes 373 of these pixels 37a are connected to a first common providing line 351. The pixels 37b in odd columns of the second row, third row, sixth row, seven row and the pixels 37b in even columns of the first row, fourth row, fifth row, eighth row, ninth row belong to a second pixel group, and common electrodes 373 of these pixels 37b are connected to a second common providing line 361.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of present invention to the full extent indicated by the broad general meaning of the terms in which the appended claims are expressed.

What is claimed is:

1. A liquid crystal display, comprising:
a liquid crystal panel, comprising:
a plurality of parallel scanning lines;
a plurality of parallel data lines perpendicular to the scanning line; and
a pixel matrix defined by the scanning lines and the data lines, the pixel matrix comprising a plurality of pixels each comprising a thin film transistor, a pixel electrode connected to a drain of the thin film transistor, and a common electrode opposite to the pixel electrode, the pixels being defined as a first pixel group and a second pixel group, the pixels in the first pixel group all having a first polarity and the pixels in the second pixel group all having a second polarity in each frame period, the first polarity and the second polarity being opposite to each other; and
a common voltage driver configured for providing a first common voltage to the common electrodes of the pixels in the first pixel group and providing a second common voltage to the common electrodes of the pixels in the second pixel group, the first common voltage and the second common voltage being an alternating voltage and having inverse phases.

2. The liquid crystal display of claim 1, wherein the liquid crystal panel further comprises a first common providing line electrically coupled between the common electrodes of the pixels in the first pixel group and the common voltage driver, and a second common providing line electrically coupled between the common electrodes of the pixels in the second pixel group and the common voltage driver.

3. The liquid crystal display of claim 2, wherein the liquid crystal panel further comprises a plurality first common lines configured to electrically connect the common electrodes of the pixels in the first pixel group to the first common providing line, and a plurality second common lines configured to electrically connect the common electrodes of the pixels in the second pixel group to the second common providing line.

4. The liquid crystal display of claim 3, wherein the first providing common line and the second providing common line are parallel to the data lines, and are located at a same side of a periphery of the pixel matrix.

5. The liquid crystal display of claim 3, wherein the first common providing line and the second common providing line are parallel to the data lines, and are respectively located at opposite sides of a periphery of the pixel matrix.

6. The liquid crystal display of claim 2, wherein the common voltage driver comprises a first common voltage generator configured to provide the first common voltage to the common electrodes of the pixels in the first pixel group via the first common providing line, and a second common voltage generator configured to provide the second common voltage to the common electrodes of the pixels in the second pixel group via the second common providing line.

7. The liquid crystal display of claim 1, wherein the first common voltage and the second common voltage have same amplitude, each of the first common voltage and the second common voltage is a continuous alternating square signal, and includes a maximum amplitude value and a minimum amplitude value.

8. The liquid crystal display of claim 7, wherein when the pixels in the first pixel group have positive polarities, the first common voltage provided to the common electrodes of the pixels in the first pixel group is the minimum amplitude value, and when the pixels in the first pixel group have negative polarities, the first common voltage provided to the common electrodes of the pixels in the first pixel group is the maximum amplitude value.

9. The liquid crystal display of claim 8, wherein when the pixels in the second pixel group have positive polarities, the second common voltage provided to the common electrodes of the pixels in the second pixel group is the minimum amplitude value, and when the pixels in the second pixel group have negative polarities, the first common voltage provided to the common electrodes of the pixels in the second pixel group is the maximum amplitude value.

10. The liquid crystal display of claim 7, further comprising a data driver configured to provide data voltages to the pixels in the first and the second pixel group, wherein the data voltages include a maximum value, a minimum value and a variation range, and the variation range of data voltages exceeds the amplitude of the first common voltage and the second common voltage.

11. The liquid crystal display of claim 10, wherein the maximum amplitude value and the minimum amplitude value of the first common voltage and the second common voltage are about 10V and about 5V, respectively.

12. The liquid crystal display of claim 10, wherein the maximum value and the minimum value of each data voltage are about 15V and about 0V, respectively.

13. The liquid crystal display of claim 1, wherein the liquid crystal display is applied with a one line dot inversion method.

14. The liquid crystal display of claim 1, wherein the liquid crystal display is applied with a one and two lines dot inversion method.

15. The liquid crystal display of claim 1, wherein positions of the thin film transistors of any two adjacent pixels in each row are the same.

16. A liquid crystal display, comprising:
a plurality of parallel scanning lines;
a plurality of parallel data lines perpendicular to the scanning lines;
a plurality of pixel units defined by the scanning lines and the data lines;
a first common providing line configured to receive a first common voltage,
a second common providing line configured to receive a second common voltage; and
a pixel matrix defined by the scanning lines and the data lines, the pixel matrix comprising a plurality of pixels each comprising a thin film transistor, a pixel electrode connected to a drain of the thin film transistor, and a common electrode opposite to the pixel electrode, the pixels being defined as a first pixel group and a second pixel group, the pixels in the first pixel group all having a first polarity and the pixels in the second pixel group all having a second polarity in each frame period, the first polarity and the second polarity being inversed, the common electrodes of the pixels in first pixel group electrically coupled to the first providing common line, and the common electrodes of the pixels in second pixel group electrically coupled to the second common providing line,
wherein the first common voltage and the second common voltage are an alternating voltage and have inverse phases.

17. The liquid crystal display of claim 16, wherein the first common voltage and the second common voltage have same amplitude, each of the first common voltage and the second common voltage is a continuous alternating square signal, and includes a maximum amplitude value and a minimum amplitude value.

18. The liquid crystal display of claim 17, wherein when the pixels in the first pixel group have positive polarities, the first common voltage provided to the common electrodes of the pixels in the first pixel group is the minimum amplitude value, and when the pixels in the first pixel group have negative polarities, the first common voltage provided to the common electrodes of the pixels in the first pixel group is the maximum amplitude value.

19. The liquid crystal display of claim 18, wherein when the pixels in the second pixel group have positive polarities, the second common voltage provided to the common electrodes of the pixels in the second pixel group is the minimum amplitude value, and when the pixels in the second pixel group have negative polarities, the first common voltage provided to the common electrodes of the pixels in the second pixel group is the maximum amplitude value.

20. The liquid crystal display of claim 17, further comprising a data driver configured to provide data voltages to the pixels in the first and the second pixel group, wherein the data voltages include a maximum value, a minimum value and a variation range, and the variation range of data voltages exceeds the amplitude of the first common voltage and the second common voltage.
